(19) United States
(12) Patent Application Publication
(10) Pub. No.: US 2006/0198378 A1
(43) Pub. Date: Sep. 7, 2006

(54) Scheduling technique for mobile uplink transmission

(75) Inventor: Jarno Rajahalme, Kirkkonummi (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/068,380

(22) Filed: Mar. 1, 2005

(51) Int. Cl. H04Q 7/00; H04L 12/56; H04L 12/28

(52) U.S. Cl. 370/395.4; 370/328

(57) ABSTRACT

An uplink scheduling technique for accessing a priority service from a mobile device (14) via a network access point (13). The access point (13) sends a request for scheduling information (2-2) to the mobile device. The mobile device (14) returns the requested scheduling information (2-4). The access point uses the requested scheduling information to determine (2-6) a filter configured for a priority service which implies better than best-effort scheduling priority for the data packets related to the priority service. The access point sends a scheduling decision (2-7) to the mobile device. The mobile device sends data packets (2-8) to the access point according to the scheduling decision. The access point receives from the mobile device an uplink data packet, the received uplink data packet matching the filter configured for the priority service.

### BACKGROUND OF THE INVENTION

The invention relates to scheduling techniques for uplink transmission from a mobile device, wherein the mobile device uses a priority service via a network access point. As used herein, a priority service means a service to the packets of which some priority-based scheduling is applied.

Prior QoS techniques, one of which is disclosed in U.S. Pat. No. 6,738,361 to Jukka Immonen et al., are based on the assumption that a mobile subscriber determines a specific QoS for each service or type of services, and the subscriber is invoiced according to the determined QoS parameters. The assignee of this application has tested such QoS techniques, and surveys carried out among pilot subscribers have revealed that the pilot subscribers find such QoS techniques difficult to understand. Keeping track of a myriad of different subscriptions is a burden to access network operators.

### BRIEF DESCRIPTION OF THE INVENTION

An object of the present invention is to provide technique for implementing the method so as to alleviate the above disadvantages. In other words, the invention seeks to provide a scheduling technique that is more easily manageable to the subscribers and the operators.

The object of the invention is achieved by a method and software as disclosed in the attached independent claims. The dependent claims disclose specific embodiments of the invention.

The invention is partially based on finding a hidden problem, ie, the fact that the well-known “you get what you pay for” metaphor leads to very complex invoicing schemes. The invention is also based on the realization that service providers instead of the mobile subscribers determine appropriate QoS parameters for each priority service.

The invention is based on the idea that prior to a mobile device's access of a priority service, the access point serving the mobile devices polls the mobile device for scheduling information, ie, sends a request for scheduling information. The mobile device sends the access point the requested scheduling information. The access point uses the requested scheduling information to determine if priority scheduling is needed by checking the information against available packet filters for priority services. Next, the access point sends a scheduling decision to the mobile device, and the mobile device sends the access point one or more uplink data packets for accessing the priority service, wherein the uplink data packets are as specified in the scheduling decision by the access point. The headers of the received uplink data packets indicate the need for the priority service, which is verified by the access point to ensure that the priority scheduling is only used when appropriate.

The polling for scheduling information and filter configuration phases may be omitted if the network load remains below a determined threshold. For instance, if the network load is low enough that the network can process each packet according to the quality needed for the priority services, there is no need to perform extra steps to prioritize some packets over others. Omitting the polling phase saves capacity of the radio link and the battery of the mobile device.

Scheduling is only practical in a busy cell, where there are multiple mobile devices willing to send data packets. The scheduling decision determines in which order and how much radio capacity is allocated to each mobile device. This decision is based on the scheduling information matching the filter(s). Thus, if a mobile device has data packets to send that relate to a priority service, the scheduler will know this by the scheduling information extracted from the packet(s) matching a filter for a priority service. Based on this information the scheduler schedules, ie, assigns the radio resources, such that the priority service will get the capacity it needs in proper time. For example, packets with real-time requirements are prioritized over delay-tolerant packets.

The scheduling technique of the present invention is easier to manage than the prior art techniques because the number of priority services is probably smaller than the number of subscribers, which is why the invention requires fewer service-specific filters than does a technique in which the service-specific filters are associated with the subscribers.

An embodiment of the invention comprises configuring, in the access point, a predetermined filter for each of several priority services.

In an embodiment the access point may discard an uplink data packet or lower its priority if it does not correspond to the selected filter.

The access point may send the request for scheduling information in a point-to-point message to each individual mobile device, or to multiple mobile devices in a broadcast or multicast message. In one embodiment, such a message can be a part of the frame structure of the underlying radio link, or a part of a radio beacon or system information message, see document 3G TS 25.304, version 3.2.0, release 1999, for example.

The requested scheduling information may comprise any information about the packet or the packet header, including the amount of data to be sent by the mobile device and/or protocol type information and/or address information for the data packets. For example, the address information may comprise IP source or destination address.

The access point may encode the scheduling decision to the DSCP (Differentiated Services Code Point) field, by overwriting it with the value associated with the filter before forwarding the uplink data packet.

An aspect of the invention is a method or software to be executed by an access point. Another aspect is a method or software to be executed by a mobile device.

### BRIEF DESCRIPTION OF THE DRAWINGS

In the following the invention will be described in greater detail by means of specific embodiments with reference to the attached drawings, in which

FIG. 1 is a signaling diagram illustrating filter management;

FIG. 2 is a signaling diagram illustrating the principle of the invention;

FIG. 3 illustrates an embodiment of the invention that uses DSCP fields of data packets for carrying QoS information; and

FIG. 4 is a simplified presentation of the various protocol stacks used in the invention.

### DETAILED DESCRIPTION OF SPECIFIC EMBODIMENTS

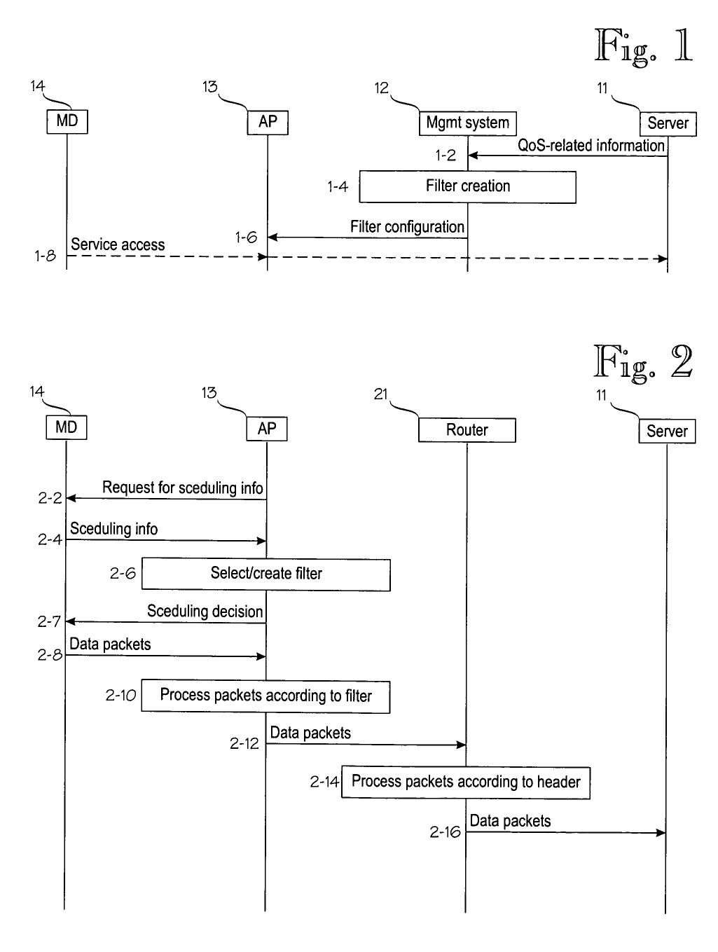

FIG. 1 is a signaling diagram illustrating filter management according to an embodiment of the invention. In this embodiment, filter configuration in an access point 13 precedes an access of a mobile device 14 to a priority service at a server 11 via the access point. In step 1-2, the server 11 (or a service provider operating the server) sends priority-related information based on which a suitable filter will ultimately be configured for the access point 13. But the access point 13 may not have the capabilities to interpret the priority-related information and the server 11 or its service operator may not be able to translate the priority-related information into parameters suitable for the access point. Accordingly, the priority-related information from several servers is sent to a management system 12, such as a suitably configured server, that collectively translates it to parameters suitable for several access points. This operation is denoted by reference numeral 1-4. In step 1-6, the management system 12 sends the filter to the access points 13. In step 1-8, the mobile device 14 uses the priority service at the server 11 via the access point 13, and this step is described in more detail in connection with FIG. 2.

FIG. 2 is a signaling diagram illustrating the principle of the invention. In step 2-2, the access point 13 sends a request for scheduling information to the mobile device 14. The access point may send this request to an individual mobile devices separately or to several mobile devices simultaneously in a multicast or broadcast message. In step 2-4, the mobile device 14 responds by sending the requested scheduling information. For example, the scheduling information may indicate that the mobile device 14 intends to send n kilobytes to the server 11 at IP address x.y.z.w and, optionally, using port pp.

In step 2-6, the access point 13 determines an appropriate filter based on the scheduling information sent by the mobile device 14. Let us first assume that a filter configuration substantially as shown in FIG. 1 has been performed earlier. In this case, the access point can determine an appropriate filter for the server 11 based on the IP address x.y.z.w and the optional port number received from the mobile device 14.

If a filter configuration as shown in FIG. 1 has not been performed, the access point 13 may create a filter from scratch based on the information sent by the mobile device. For instance, the filter may be created based on protocol type, IP port number, or the like. Alternatively, the access point 13 may detect some address information of the server 11, such as the server's IP or URL address, and request for priority-related information either from the server itself or from some other entity, such as the management system 12 shown in FIG. 1.

In step 2-7, the access point AP sends the mobile device MD a scheduling decision, granting the mobile device MD some usage of the radio resources.

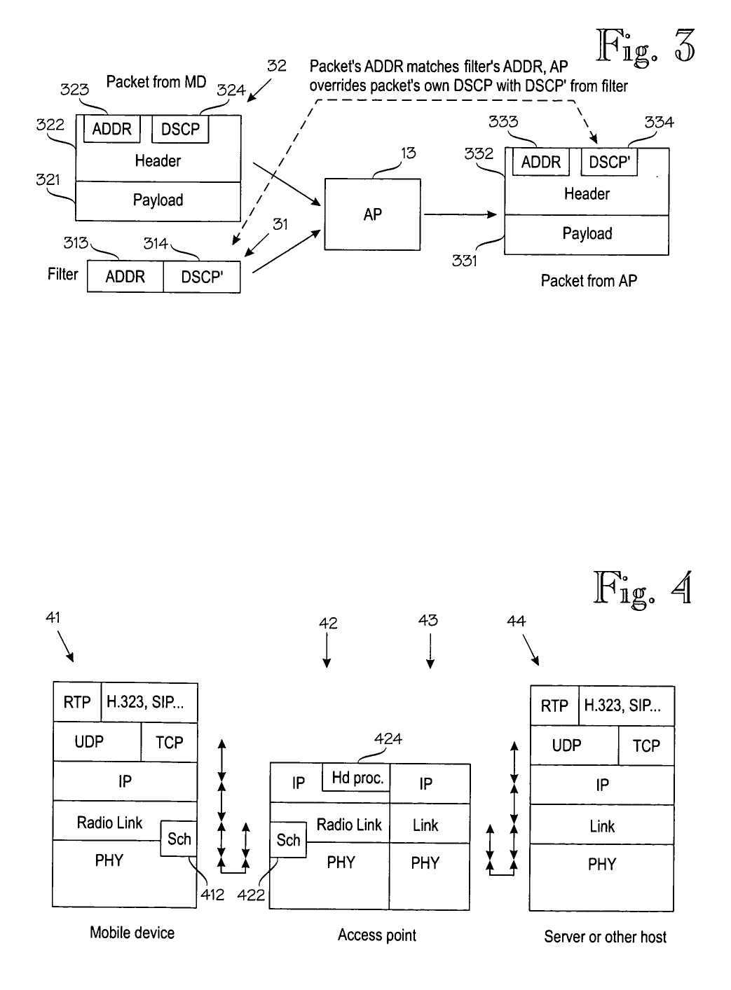

In step 2-8, the mobile device 2-8 sends data packets to the access point 13, in order to access the priority service at the server 11. In step 2-10 the access point 13 examines one or more parameters in the headers of the data packets (or one of the data packets) sent by the mobile device, in order to verify that the data packets sent in step 2-8 correspond to the scheduling information sent by the mobile device in step 2-4. If the data packets sent in step 2-8 correspond to the scheduling information sent earlier, the access point 13 processes the data packets according to the filter that was determined in step 2-6. This processing is denoted by reference numeral 2-10. For instance, such processing of packets may comprise overriding some priority-related parameters in the packet headers, as shown in more detail in FIG. 3, that shows a specific embodiment of the invention. On the other hand, if the data packets sent in step 2-8 do not correspond to the scheduling information sent in step 2-4, the access point 13 may discard the data packets or lower their priority. In one embodiment lowering priority means applying another filter to the packets. In step 2-12, the access point 13 sends the data packets via a router 21 to the server 11. In step 2-14 the router processes the data packets in a conventional manner, according to QoS parameters in the packet headers. In step 2-16, the router conveys the data packets to the server 11. If the service is bi-directional, the server 11 responds by sending data packets to the mobile device 14, and the server 11 may use the QoS parameters in the packet headers to configure the packets that constitute the downlink part of the service.

In one embodiment of the invention, the polling for scheduling information prior to actual service usage is only performed when the network load exceeds some predetermined threshold. As long as the network load remains below that threshold, steps 2-2, 2-4, 2-6 and 2-10 may be omitted. In one embodiment of the invention, also the step 2-7 may be omitted. This corresponds to the situation where there is no scheduling being performed by the AP at all, but MDs can send when they sense the frequency to be free (as in Ethernet). If the step 2-7 is NOT omitted, while the earlier steps are being omitted, the AP will schedule without any specific scheduling info, maybe in round-robin fashion, giving each terminal some resource that they then either use or not.

In FIGS. 1 and 2, the data packets sent by the mobile device 14 terminate at the server 11, but this is only an illustrative example, and the term “server” should be interpreted as any networked entity that provides one or more services. For example, the service may be a call, chat or audio/video conference between two or more terminals, in which case the server conveys the data packets from one terminal to one or more other terminals, or the service may be implemented in another terminal, without there being a server in the middle at all.

FIG. 3 illustrates an embodiment of the invention that uses DSCP fields of data packets for carrying QoS information. Reference numeral 32 denotes a data packet sent by the mobile device. The data packet comprises a payload 321 and a header 322. The header in turn comprises a destination address field 323 and QoS information, which in this embodiment is represented by a DSCP (Differentiated Services Code Point) field 324. The access point 13 receives the data packet 324 from the mobile device 14. It has also pre-configured, or will configure on-the-fly, a filter 31, that also comprises an address field and a DSCP′ field, denoted respectively by reference numerals 313 and 314. The prime in the DSCP′ field 314 indicates that the contents of this field may differ from the contents of the corresponding field 324 in the packet sent by the mobile device.

The access point 13 examines the header 322 of the mobile-originated data packet 32. In this embodiment, the access point 13 examines particularly the address field 323 and verifies that the contents of the address field 323 corresponds to the contents of the address field 313 of the filter 31. If the address fields 323 and 313 match, the access point 13 processes the data packet according to the filter. The address matching may be decided on the basis of either all or part of the bits in the two addresses having the same value, which covers the case wherein the filter specifies a wildcard instead of a full address. For example, a filter with an address of “123.24.*.*” would match any packets having an address which begins with “123.24”. In this embodiment, such processing comprises overriding the DSCP field 324 of the mobile-originated packet 32 with the DSCP′ field 314 of the filter 311.

The particular fields shown in FIG. 3 are illustrative but non-restricting examples, and other fields may be used as well. Instead of determining an appropriate filter 31 based on the destination ADDR field 323, source address, flow label, protocol type (TCP/UDP, RTP, etc.), IP port number, or the like. Likewise, the priority-related information may be conveyed in fields other than the DSCP field.

FIG. 4 is a simplified presentation of the various protocol stacks used in the invention. Reference numerals 41 and 44 respectively denote protocol stacks at the mobile device and server (or other host). Reference numerals 42 and 43 respectively denote the access point's protocol stacks toward the wireless interface (mobile device) and data network (server). These protocol stacks are simplified versions but suffice to illustrate the invention. As usual, the lowest levels of each protocol stack are a physical layer, Link or Radio Link layer and an Internet Protocol layer. The mobile device and server or other host have higher levels, as required by the applications, such as UDP/TCP and RTP/H.323/SIP.

As shown in FIG. 4, the invention can be implemented by changes in the physical and/or radio link layers of the mobile device and access point and in the Internet Protocol layer of the access point. In this example, the access point's protocol stack 42 toward the mobile device, as well as the mobile device's protocol stack 41, comprises a scheduling function 422, 412, respectively. The two scheduling functions 422, 412 cooperate to perform the steps 2-2, 2-4 and 2-6 shown in FIG. 2. In addition, the Internet Protocol layer of the access point comprises a header processing function 424 that performs step 2-10, a specific example of which was described in connection with FIG. 3. Thus the invention does not require any changes in the server or other host, or in the higher layers of the mobile device.

In addition to the protocol changes shown in FIG. 4, some embodiments of the invention involve a management system, shown as item 12 in FIG. 1. The management system is programmed to receive priority-related information from several servers or service providers, to process the received priority-related information into filters suitable for several access points, and to distribute the processed filters to several access points.

1. An uplink scheduling method for accessing a priority service from a mobile device via a network access point, the method comprising:
a) the access point sending a request for scheduling information to the mobile device;
b) the access point receiving from the mobile device the requested scheduling information;
c) the access point using the requested scheduling information to determine a filter configured for a priority service, wherein the priority service implies better than best-effort scheduling priority for the data packets related to the priority service;
d) the access point sending a scheduling decision to the mobile device;
e) the access point receiving uplink data packets from the mobile device, the received uplink data packets matching the filter configured for the priority service.

2. A method according to claim 1, further comprising: configuring in the access point a predetermined filter for each of several priority services.

3. A method according to claim 1, wherein the access point determines the scheduling priority of the received data packets on the links from the access point towards the network according to the priority information associated with the filter matched by the data packets.

4. A method according to the claim 3, wherein the access point maps the determined scheduling priority to a Differentiated Services Code Point, or DSCP value, and forwards the received data packets according to the forwarding treatment specified for the selected DSCP value.

5. A method according to claim 1, wherein the received uplink packet comprises a Differentiated Services Code Point, or DSCP, field, and the access point overwrites the DSCP field of the received uplink packet according to the rules associated with the filter matched by the data packets before forwarding the uplink data packet.

6. A method according to claim 1, wherein some of the steps of claim 1 are performed only in response to a determination that traffic load in the access link exceeds a predetermined threshold.

7. A method according to claim 1, wherein the access point discards the received uplink data packet or lowers its priority if the received uplink data packet was scheduled based on a priority service, but the received uplink data packet does not correspond to the selected filter.

8. A method according to claim 1, wherein the access point sends the request for scheduling information in a broadcast or multicast message.

9. A method according to claim 8, wherein the broadcast or multicast message is a radio beacon or system information message, or part of the radio link frame structure.

10. A method according to claim 1, wherein the requested scheduling information comprises an amount of data to be sent by the mobile device.

11. A method according to claim 1, wherein the requested scheduling information comprises one or more fields of the packet header.

12. A method according to claim 11, wherein the requested scheduling information comprises a packet destination address corresponding to the priority service.

13. A method according to claim 12, wherein the packet destination address is an Internet Protocol (IP) address.

14. Software for an access point of an access network, the software comprising program routines for causing the access point to execute the steps of:
a) the access point sending a request for scheduling information to the mobile device;
b) the access point receiving from the mobile device the requested scheduling information;
c) the access point using the requested scheduling information to determine a filter configured for a priority service, wherein the priority service implies better than best-effort scheduling priority for the data packets related to the service;
d) the access point sending scheduling decision to the mobile device;
e) the access point receiving from the mobile device an uplink data packet, the received uplink data packet matching the filter configured for the priority service.

15. An access point for an access network, the access point comprising the software according to claim 14.

16. Software for a mobile device for sending uplink data packets via a network access point for accessing one or more priority services, the software comprising program routines for causing the mobile device to execute the steps of:
a) receiving a request for scheduling information from the access point;
b) responding to the request for scheduling information by sending the requested scheduling information to the access point;
c) receiving the scheduling decision from the access point; and
d) sending to the access point uplink data packets that correspond to the received scheduling decision.

17. A mobile device for a mobile network, the mobile device comprising the software according to claim 16.

18. A management system for a packet data network, the management system comprising:
means for receiving scheduling priority related information from each of a plurality of priority service providers; and
means for processing the received scheduling priority related information into filters suitable for access points of an access network; and
means for distributing the processed filters to a plurality of access points of the access network.
